(19) United States
(12) Patent Application Publication
(10) Pub. No.: US 2021/0403130 A1
(43) Pub. Date: Dec. 30, 2021

(54) Prop Impact Detector

(71) Applicant: Pinpoint Ideas, LLC, Knoxville, TN (US)

(72) Inventors: Joseph Anthony Czarnecky, Okauchee, WI (US); Steven Andrew Rook, Cary, IL (US); Scott Allen Crutchfield, Oconomowoc, WI (US); Gregory Parker Stair, Knoxville, TN (US)

(21) Appl. No.: 17/361,443

(22) Filed: Jun. 29, 2021

Related U.S. Application Data
(60) Provisional application No. 63/045,344, filed on Jun. 29, 2020.

(51) Int. Cl. B63B 79/30; G01S 19/01; G01M 1/14; B63B 79/10; B63H 1/14

(52) U.S. Cl. CPC B63B 79/30; G01S 19/01; B63H 1/14; B63B 79/10; G01M 1/14

(57) ABSTRACT

A system for determining mechanical failure in a boat, power sports vehicle, recreational vehicle or other asset system is provided comprising attaching one or more sensors to the asset system, using the one or more sensors to gather data regarding physical characteristics of the asset system, providing a dashboard configured to receive the data from the one or more sensors and transmit to devices upon request, providing a GPS device configured to collect and transmit data regarding asset characteristics, providing a server which is configured to receive the data regarding physical characteristics of the asset, store the data in a database, and make determinations of mechanical failures based on the data received from the one or more sensors, providing a mobile application configured to display information regarding the status, and sending out notifications.

### CROSS-REFERENCE TO RELATED APPLICATIONS

This application claims the benefit of U.S. Provisional Application No. 63/045,344, filed on Jun. 29, 2020, incorporated herein by reference, in its entirety, for any purpose.

### BACKGROUND

Global Positioning System (GPS) devices with cellular modems have been used for many years to provide accurate geolocation and time information to users anywhere on or near the earth. Although originally created for military use, these devices can be used for a number of different purposes including fleet tracking, geofencing, data mining, robotics and athletics.

Such a GPS tracking device can be tied to specific manufacture data such as date, model, color, accessories, and engine details, and data can be gathered regarding time and location of sales and boat delivery. This data can be mined and augmented to assist in providing failure rates of models with certain options and accessories or on a given body of water, time of day, week, month etc.

GPS tracking devices can provide a boat, power sports vehicle, recreational vehicle or other asset system with software that determines a frequency of data transmissions required as the boat, power sports vehicle or recreational vehicle asset moves from a manufacturer to a consumer and collects the data that the GPS tracking device sends through wireless, cellular, WIFI or Blue Tooth technology, firmware within a chip on the GPS tracking device that determines how often data is sent from the GPS tracking device to the software controller application, and an accelerometer attached to the GPS tracking device that determines whether the GPS tracking device is moving or stationary, while registering the magnitude of acceleration or deceleration. The same system can also be used with trailers, outboard engines, wave runners, and other assets.

Additionally, it would be beneficial to be able to detect a mechanical or other issue with the boat, including detecting a propeller strike from the GPS device. The GPS device can be used along with a vibration sensor, and other sensors such as an accelerometer, to monitor the vibration in a boat or engine and then identify when and where the propeller strike occurred based on when the vibration changed and by how much. These abrupt changes in the harmonics can be noted and recorded by a server in communication with the GPS device. This same method can also be used to detect when a boat or engine runs aground. Additionally, this system can be used with regard to attachments to the powersports and/or recreational asset, such as trailers as mentioned above. The information would be sent from the GPS device to a software application via wireless technology.

### SUMMARY OF THE INVENTION

Embodiments of the present general inventive concept provide a method for determining mechanical failure in a boat power sports vehicle, recreational vehicle or other asset system comprising attaching one or more sensors to the boat, power sports vehicle, recreational vehicle or other asset; using the one or more sensors to gather data regarding physical characteristics of the boat, power sports vehicle, recreational vehicle or other asset; providing a dashboard configured to receive the data from the one or more sensors and transmit to devices upon request; providing a GPS device configured to collect and transmit the data regarding physical characteristics of the power sport, recreational vehicle or other asset; providing a server which is configured to receive the data regarding physical characteristics of the boat, power sports vehicle, recreational vehicle or other asset, store the data in a database, and make determinations of mechanical failures in the boat, power sports vehicle, recreational vehicle or other asset based on the data received from the one or more sensors; providing a mobile application configured to display information regarding the status of the boat, power sports vehicle, recreational vehicle or other asset; sending notifications to the mobile application from the server upon the occurrence of a mechanical failure of the boat, power sports vehicle, recreational vehicle or other asset; and providing a wired or wireless connection between the one or more sensors, dashboard, GPS device, server and mobile application.

Example embodiments of the present general inventive concept can be achieved by providing a system for determining mechanical failure in a boat, power sport vehicle, recreational vehicle or other asset system comprising one or more sensors to the boat, power sports vehicle, recreational vehicle or other asset; a dashboard configured to receive the data from the one or more sensors and transmit to devices upon request; a GPS device configured to collect and transmit the data regarding physical characteristics of the boat, power sports vehicle, recreational vehicle or other asset; a server which is configured to receive the data regarding physical characteristics of the boat, power sports vehicle, recreational vehicle or other asset, store the data in a database, and make determinations of mechanical failures in the boat, power sports vehicle, recreational vehicle or other asset based on the data received from the one or more sensors; and a mobile application configured to display information regarding the status of the boat, power sports vehicle, recreational vehicle or other asset.

### BRIEF DESCRIPTION OF THE DRAWINGS

Example embodiments of the present general inventive concept will become more clearly understood from the following detailed description of the present general inventive concept read together with the drawings in which:

FIG. 1 is a schematic diagram of an embodiment of the Prop Impact Detector system and method.

### DETAILED DESCRIPTION

Reference will now be made to the example embodiments of the present general inventive concept, examples of which are illustrated in the accompanying drawing(s) and illustration(s). The example embodiments are described herein in order to explain the present general inventive concept by referring to the FIGURE(s). The following detailed description is provided to assist the reader in gaining a comprehensive understanding of the structures described herein. Accordingly, various changes, modification, and equivalents of the structures and techniques described herein will be suggested to those of ordinary skill in the art. The descriptions are merely examples, however, and the sequence type of operations is not limited to that set forth herein and may be changed as is known in the art, with the exception of operations necessarily occurring in a certain order. Also, description of well-known functions and constructions may be omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the FIGURES. Spatially relative terms are intended to encompass different orientations of the device in use or operation in addition to the orientation depicted in the FIGURES. For example, if the device in the FIGURES is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

This invention can be used for determining the exact timing of a mechanical failure in a power sport, recreational vehicle or other asset system. In one embodiment of the present concept, the invention will be able to identify if a motor boat propeller has struck an object or the ground while under power or if the propeller blades have become damaged. In addition, it will be able to indicate if the propeller is out of balance. This will also be able to indicate if the boat has run aground while under power. The invention will be able to indicate if the propeller shaft, lower unit bearings, the couplings or the gimble gears are operating differently than they normally do and should be inspected. The invention will also be able to determine if a wheel is going flat or other conditions indicated by abnormal engine vibrations.

A GPS device and system, attached to a boat or other asset, includes a software application controller to monitor the status of the GPS device battery and determine the intensity of the tracking information desired as the asset and GPS device is moved from the manufacturer to the consumer. The GPS device is mounted within the boat or other asset on the assembly line or in the field at such location as a dealer, for example, and is carried on the boat from the manufacturer to the dealer and ultimately to the consumer. Firmware is located within the chip on the GPS device which controls how often the data is sent from the GPS device to the software application controller. Additionally, the software can alter how often the GPS tracking device sends position data transmissions. The time interval between position data transmissions from the GPS device will vary dependent on the location, movement, presence of a geofence, and other factors, in order to conserve battery power. The GPS device has an on-board sensor to determine whether it is moving or stationary.

Movement of the GPS device within the asset, coupled with software that communicates with the GPS device, can further provide marketing information. For example, the GPS device may be associated with the manufacture date, model, accessories, color, engine or other data concerning the boat or other asset and can gather data regarding time and location of sales and boat or other asset delivery. This data can then be mined and augmented to assist in providing inventory control which may include information as to how long a boat or other asset stays on the dealer's lot, when it is sold, and such information can be used as feedback to the manufacturer to assist in determining the type, color, length and other characteristics of boats or other assets which are moving quickly and are more desirable. This type of marketing data collected by the GPS device can be sold to a manufacturer, dealer, floor plan companies, insurance companies, and others, on a subscription basis

In the present general inventive concept, if the boat propeller was struck or the boat runs aground while under power, the invention will be able to indicate when and where the strike happened if on the water. If the propeller was stuck while not under power and the propeller is out of balance, the invention will be able to indicate when the last time the boat was used and the propeller was normal and the next time the boat was used and the propeller is not normally operating. Another example of the present general inventive concept would be regarding detecting improper functioning of the impeller of a wave runner, which could be caused by the impeller being out of balance, bent, or chipped.

The invention can determine the last time the boat was used under normal conditions and when the boat started to be used and continued to be used under abnormal conditions because of a propeller strike or the propeller is out of balance. This can be useful to warn the user that there is an issue and they may be able to avoid further damage by discontinuing use until the boat is inspected and or repaired.

The System can notify the user or owner of the boat, the dealer and the manufacture of the boat, motor and motor components and the propeller manufacture.

The invention will use internal and external sensors that can transmit the information to the dashboard for other devices to read or as in our case the sensors can transmit the information through a wire or wirelessly to our GPS device. The GPS device will have electronic chip boards that read the information and then transfer the information wirelessly via a sim card and through wireless carriers to servers. Optionally the GPS device can also transmit the data via Wi-Fi or Bluetooth to other device receivers that then transfer the data through the internet to the server, or to a mobile device that intern transfers the data through the internet to the servers.

The server stores the historical data related to the boat and constantly compares the historical data with the new data to determine if the propeller on the boat has had an impact or is out of balance. The same is done to identify if the lower unit bearings, the couplings or the gimble gear may be operating abnormally. The server stores the historical data and constantly compares the historical data with the new data to determine if the boat has run aground.

The server can compare only one type of data or various types of data through an algorithm to determine any of the scenarios listed. The types of data comparisons will vary based on the type of engine and propulsion system the boat has, depending on if it is an outboard, inboard outboard, a direct drive or an inboard with a Pod drive.

The various sensors used in the invention are an accelerometer, heat probe, vibration, sound and harmonics. The sensors measure one or more of any of the following: vibration, harmonic vibration, sound, heat, speed, RPM, and G Force.

The location to mount the senor or sensors may be only one location or many locations depending upon the type of boat and propulsion system. Mounting locations include the strut, shaft seals, engine, engine mounts, transmission, transmission mounts, gear case, boat hull, ski pylon, ski pylon mounts, wakeboard tower, wakeboard tower mounts, steering rudder, steering wheel box, steering cable, lower unit, pod, gimble housing in the lower unit or pod bearings in the transmission, lower unit or pod, couplings in the lower unit or pod.

This invention should include the option of the device on the boat to be able to make the comparison of data and send the information to the dashboard system or notify the user on the phone. It is important note that as chips advance, this will be able to have some comparison on the device on the boat to accomplish this.

In addition to boat propeller strikes, the same general inventive concept can be applied to other power sports issues, such as the ability to detect clutch vibrations. This can tell the user if the clutch has issues like the rollers or weights or the belts are wearing and getting ready to break.

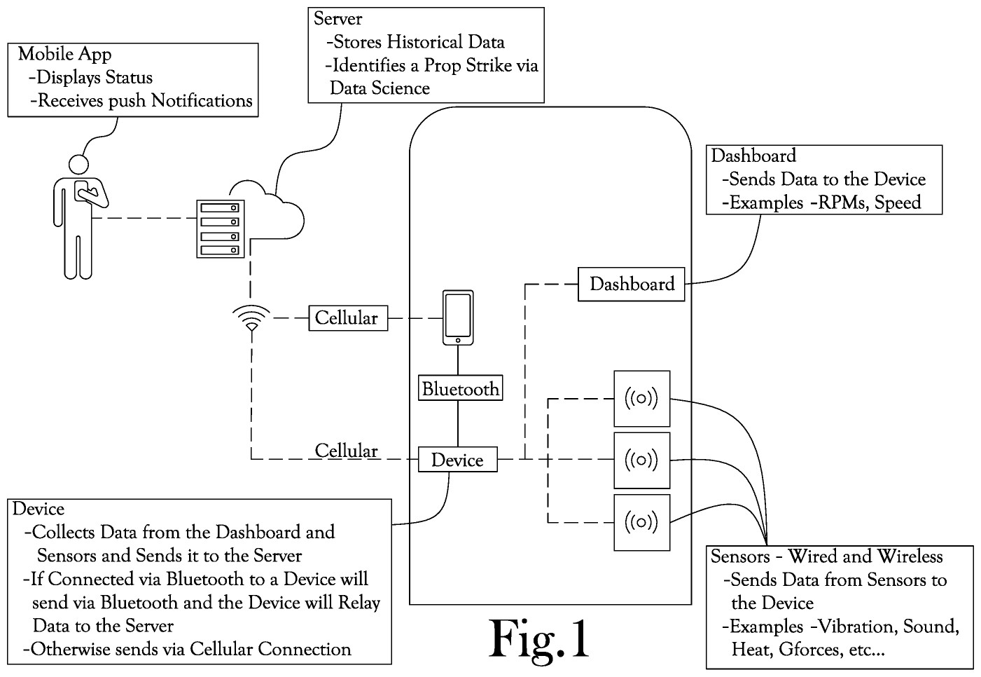

The attached FIG. 1 shows the operation of the present general inventive concept. Multiple sensors are employed for tracking physical characteristics of the boat propeller including, but not limited to, vibration, harmonic vibration, sound, heat, speed, RPM, and G Forces. These sensors can be both wired and wireless. The sensors can send the recovered physical data directly to the GPS device through the wired or wireless connection. Alternatively, the sensors can send the recovered physical data to a dashboard for other devices to read.

As shown in FIG. 1, the GPS device collects data from either the dashboard or sensors, and send that data to a server. The server stores the historical data related to the boat, power sports vehicle, recreational vehicle or other asset. Based on analysis of the data, the server can determine if there is a propeller strike or other mechanical fault. The GPS device may have electronic chip boards that read the information and then transfer the information wirelessly via a sim card and through wireless carriers to a server. Alternatively, the GPS device can also transmit the data via Wi-Fi or Bluetooth to other device receivers, that then transfer the data through the internet to the server, or to a mobile device that in turn transfers the data through the internet to the server(s). Finally, the operator has a mobile application on their phone that displays the status of the power sport, recreational vehicle or other asset, and can also receive push notifications regarding any detected fault.

This invention includes a screen that displays the various modes of the GPS device. It is envisioned that a charge will be made to the customer to enable more frequent transmissions and a readout showing the mode and battery life left. The user will be able to know the battery life remaining in any of the modes. They will be able to switch to any of the modes and know the battery life left in the selected mode. The user will also be able to enter into a specific mode and change the frequency of transmissions to assist in location and tracking and know the battery life based on the frequency of transmissions they have set the software application and tracking device to. The software application will communicate with the GPS device to change the frequency of the transmissions.

Location may be based on the geolocation of the WIFI. For example, the first step in determining the GPS device's position may be to determine the distance between the target client tracking device and a couple of access points. With the distances between the target device and access points known, trilateration algorithms may then be used to determine the relative position of the target device, and using as a reference the known position of access points. In another embodiment, the angle of arriving signals at a target client device may be employed to determine the tracking device's location based on triangulation algorithms. Various combination of these approaches may be used to increase the accuracy of the system. Location may also be based on the location of a Bluetooth compliant tracking device, for example a smartphone, which is coupled with the tracking device.

If the GPS device is on a WIFI network, location may be transmitted based on a WIFI crowdsourced location engine. The frequency of transmission can be defined by the user in a range between a minimum and a maximum, for example from every five minutes to once per hour and it will be over a cellular radio, since it will not be able to rely on being connected within the WIFI network. Finally, if the GPS device is not on either Bluetooth or WIFI, a location fix with assisted location will be performed, for example by using cell tower triangulation. This will be performed at a frequency that can be defined by the user in a range between a minimum and a maximum, for example from every five minutes to once per hour, using the cellular network, and transmitted to the platform. In addition to the cellular location approach, a GPS tracking fix may also be performed every fifth, or other specified, interval, in order to increase the accuracy of the trail. However, the GPS tracking fix may only be considered necessary if the tracking device is determined to be on the move.

While various aspects of the invention are described, it will be apparent to those of ordinary skill in the art that other embodiments and implementations are possible within the scope of the invention. Accordingly, the invention is not to be restricted except in light of the attached claims and their equivalents.

Having thus described the aforementioned invention, what is claimed is:

1. A method for determining mechanical failure in a boat power sports vehicle, recreational vehicle or other asset system comprising:
attaching one or more sensors to the boat, power sports vehicle, recreational vehicle or other asset;
using the one or more sensors to gather data regarding physical characteristics of the boat, power sports vehicle, recreational vehicle or other asset;
providing a dashboard configured to receive the data from the one or more sensors and transmit to devices upon request;
providing a GPS device configured to collect and transmit the data regarding physical characteristics of the power sport, recreational vehicle or other asset;
providing a server which is configured to receive the data regarding physical characteristics of the boat, power sports vehicle, recreational vehicle or other asset, store the data in a database, and make determinations of mechanical failures in the boat, power sports vehicle, recreational vehicle or other asset based on the data received from the one or more sensors;
providing a mobile application configured to display information regarding the status of the boat, power sports vehicle, recreational vehicle or other asset;
sending notifications to the mobile application from the server upon the occurrence of a mechanical failure of the boat, power sports vehicle, recreational vehicle or other asset; and
providing a wired or wireless connection between the one or more sensors, dashboard, GPS device, server and mobile application.

2. The method of claim 1, wherein the sensors include one or more of the following: accelerometer, heat probe, vibration, sound and harmonics sensors.

3. The method of claim 2, wherein the physical characteristics measured by the sensors include the following: vibration, harmonic vibration, sound, heat, speed, RPM, and G Forces

4. The method of claim 3, wherein the mechanical failure determined by the server is related to a propeller.

5. The method of claim 4, wherein the propeller is determined to be operating in an unbalanced state.

6. The method of claim 4, wherein the propeller has struck an object or the ground while under power.

7. The method of claim 4, wherein the propeller shaft, lower unit bearings, couplings or the gimble gears are operating in a faulty manner.

8. The method of claim 3, wherein the mechanical failure determined by the server is damage to the clutch, including roller, weights, or belt failure.

9. A system for determining mechanical failure in a boat, power sport vehicle, recreational vehicle or other asset system comprising:
one or more sensors to the boat, power sports vehicle, recreational vehicle or other asset;
a dashboard configured to receive the data from the one or more sensors and transmit to devices upon request;
a GPS device configured to collect and transmit the data regarding physical characteristics of the boat, power sports vehicle, recreational vehicle or other asset;
a server which is configured to receive the data regarding physical characteristics of the boat, power sports vehicle, recreational vehicle or other asset, store the data in a database, and make determinations of mechanical failures in the boat, power sports vehicle, recreational vehicle or other asset based on the data received from the one or more sensors; and
a mobile application configured to display information regarding the status of the boat, power sports vehicle, recreational vehicle or other asset.
